(19) United States
(12) Patent Application Publication
(10) Pub. No.: US 2020/0104887 A1
(43) Pub. Date: Apr. 2, 2020

(54) TECHNIQUES FOR IDENTIFYING INGENUINE ONLINE REVIEWS

(71) Applicant: Apple Inc., Cupertino, CA (US)

(72) Inventors: Sarah Y. CUMMINGS, San Jose, CA (US); Tu OUYANG, Fremont, CA (US)

(21) Appl. No.: 16/147,089

(22) Filed: Sep. 28, 2018

(51) Int. Cl. G06Q 30/02; G06Q 30/00; G06F 17/27

(52) U.S. Cl. CPC G06Q 30/0282; G06Q 30/0185; G06F 17/274; G06F 17/277; G06F 17/2705

(57) ABSTRACT

The embodiments set forth a technique for enabling a server device to identify ingenuine online reviews and prevent them from publishing. According to some embodiments, the technique can include the steps of (1) receiving an online review from a client device, where the online review includes a review component that comprises text; (2) parsing the text into two or more tokens; (3) assessing a probability of gibberish associated with the text by: (i) assigning a part of speech to each token; (ii) pairing consecutive tokens into speech pairings; (iii) calculating, for each speech pairing, a conditional probability value; and (iv) aggregating the conditional probability values to calculate the probability of gibberish associated with the text (4) and in response to determining that the probability of gibberish satisfies a threshold amount, tagging the online review as ingenuine to prevent the online review from being published.

### FIELD

The described embodiments relate generally to identifying ingenuine online reviews. More particularly, the described embodiments set forth techniques for identifying ingenuine online reviews based on a calculated probability of whether gibberish text is included in a review component of an online review.

### BACKGROUND

The proliferation of online stores has contributed to the popularity of online reviews. As is well known, an individual can purchase a product through an online store and subsequently leave an online review that consists of both a rating and a narrative for prospective patrons to read. In some cases, the rating can serve as an objective quality indicator (e.g., a star rating) for the online store itself and/or a product purchased through the online store. Similarly, the narrative can serve as a subjective quality indicator (e.g., one or more written sentences) for the online store itself and/or a product purchased through the online store. These online reviews provide a valuable service in that they can help prospective patrons make informed decisions about whether to purchase a particular good through the online store.

Notably, online reviews can be helpful as long as they provide substantive and genuine information. Unfortunately, online reviews typically are littered with ingenuine online reviews, which can be established for a variety of reasons. For example, individuals often are incentivized to leave online reviews in exchange for a discount on a product or some other incentive. In another example, fake online reviews may be offered as a service by entities that utilize bot accounts, contracted online review submitters, and so on.

As described above, online reviews typically include both rating and review components. Of note, it can be easy to provide the rating component (e.g., selecting a star), but it takes considerable effort to provide a genuine review component (e.g., typing a narrative). In this regard, the review components of ingenuine online reviews are often completed in haste, e.g., where users input gibberish on their keyboards simply to satisfy the criteria to submit the online review (e.g., a minimum number of characters). As a result, a given online store can be associated with numerous online reviews that include both ingenuine rating and review components. In many cases, it is insurmountable for the online store to be able to distinguish between genuine and ingenuine online reviews, thereby enabling the ingenuine reviews to persist. Consequently, prospective patrons can be misled by ingenuine online reviews, which detracts from their overall experience.

### SUMMARY

Representative embodiments set forth herein disclose various techniques for enabling a server device to identify and filter ingenuine online reviews from genuine online reviews.

According to some embodiments, a method is disclosed for identifying ingenuine online reviews. The method can be implemented at a server device, and include the steps of (1) receiving an online review from a client device, where the online review includes a review component that includes text; (2) parsing the text into two or more tokens; (3) assessing a probability of gibberish associated with the text by: (i) assigning a part of speech to each token, (ii) pairing consecutive tokens into speech pairings, (iii) calculating, for each speech pairing, a conditional probability value that the speech pairing falls within a gibberish category, and (iv) aggregating the conditional probability values to calculate the probability of gibberish associated with the text; and (4) in response to determining that the probability of gibberish satisfies a threshold amount, tagging the online review as ingenuine to prevent the online review from being published.

According to some embodiments, another method is disclosed for identifying ingenuine online reviews. The method can be implemented at a server device, and include the steps of (1) receiving an online review from a client device, where the online review includes a review component that includes text; (2) separating the text into a first part that includes letters and spaces occurring consecutively between punctuation marks within the text, and a second part that includes letters and spaces occurring consecutively between punctuation marks within the text; (3) tracking a number of characters occurring within the first and second parts in a list; (4) identifying a largest number from the list; (5) calculating a probability that the text is gibberish based on the largest number; and (6) in response to determining that the probability satisfies a threshold amount, tagging the online review as ingenuine to prevent the online review from being published.

According to some embodiments, yet another method is disclosed for identifying ingenuine online reviews. The method can be implemented at a server device, and include the steps of (1) receiving an online review from a client device, where the online review includes a review component the includes text; (2) for each word within the text, identifying a letter located in a predefined position of each word to produce an identified letter; (3) mapping individual identified letters to respective locations on a computer keyboard, where the respective locations include one or more keys of the computer keyboard and the respective locations do not overlap; (4) for each of the respective locations, determining a percentage of letters located within a respective location to create an occurrence percentage; (5) calculating a probability that the text is gibberish based on the occurrence percentages; and (6) in response to determining that the probability satisfies a threshold amount, tagging the online review as ingenuine to prevent the online review from being published.

According to some embodiments, a further method is disclosed for identifying ingenuine online reviews. The method can be implemented at a server device, and include the steps of (1) receiving an online review from a client device, where the online review includes a review component that includes text; (2) calculating a percentage of unique characters occurring in the text to create the percentage of unique characters; (3) calculating a probability that the text is gibberish based on the percentage of unique characters; and (4) in response to determining that the probability satisfies a threshold amount, tagging the online review as ingenuine to prevent the online review from being published.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different computing devices that can be configured to implement different aspects of the various techniques described herein, according to some embodiments.

FIGS. 2A-2F illustrate conceptual and method diagrams in which a server device applies a technique to identify an ingenuine online review, according to some embodiments.

FIGS. 3A-3F illustrate conceptual and method diagrams in which a server device applies a technique to identify an ingenuine online review, according to some embodiments.

FIGS. 4A-4F illustrate conceptual and method diagrams in which a server device applies a technique to identify an ingenuine online review, according to some embodiments.

FIGS. 5A-5C illustrate conceptual and method diagrams in which a server device applies a technique to identify an ingenuine online review, according to some embodiments.

FIG. 6 illustrates a detailed view of a computing device that can represent the computing devices of FIG. 1 used to implement the various techniques described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The embodiments described herein set forth techniques for enabling a server device—e.g., any form of a computing device, or network of computing devices—to filter ingenuine online reviews from publishing. The server device can be associated with an online store and be configured to publish online reviews associated with the online store. An ingenuine online review can include a review component including text that is gibberish. In some scenarios, the gibberish text is created when a user inputs gibberish as text for the review component. The server device can identify a probability that an online review is ingenuine, which can be inferred when the server device identifies gibberish text.

According to some embodiments, the server device can implement different techniques that enable the server device to identify an ingenuine online review. Using a first technique, the server device can receive, from a client device, an online review with a review component that includes text. The server device can parse the text into two or more tokens and assess the probability of gibberish associated with the text by further analyzing the tokens. According to some embodiments, the server device can assign a part of speech to each token (e.g., identify a token as a noun, adverb, pronoun, and the like). Next the server device can pair consecutive tokens into speech pairings, and calculate, for each speech pairing, a conditional probability value that the speech pairing falls within a gibberish category.

The server device can aggregate the conditional probability values to calculate the probability of gibberish associated with the text. If the probability of gibberish satisfies a threshold amount, the server device can tag the online review as ingenuine to prevent the online review from being published. Certain types of speech pairings can occur more frequently in text that is non-gibberish because non-gibberish text tends to follow grammatical rules. Accordingly, using the first technique, the server device can utilize data about the certain types of speech pairings that can occur more frequently in non-gibberish text to calculate the probability of gibberish associated with the text.

Using a second technique, after receiving the online review from a client device, the server device can separate the text into parts delimited by punctuation marks. Based on the part that includes the longest string of characters, the server device can calculate a probability that the text is gibberish. Similar to the previous technique, if the probability of gibberish satisfies a threshold amount, the server device can tag the online review as ingenuine to prevent the online review from being published.

Using a third technique, after receiving the online review from a client device, the server device can map individual identified letters in the text to respective locations on a computer keyboard. In particular, the server device can assess whether the text uses Roman letters, and in a scenario where the text does not use Roman letters, the server device translates the text to Roman equivalents (e.g., translate Chinese characters to Pinyin equivalents). The server device can identify a letter located in a predefined position of each Roman word or equivalent (e.g., identify the first letter in each Roman word or equivalent), and map the individual identified letter to respective locations on a computer keyboard. In some examples of gibberish text, a user will repeatedly input keys from the same row on a keyboard. Using the third technique, the server device can utilize a percentage of characters originating at particular parts of a keyboard to calculate a probability of gibberish of the text. Similar to the previous techniques, if the probability of gibberish satisfies a threshold amount, the server device can tag the online review as ingenuine to prevent the online review from being published.

Using a fourth technique, after receiving the online review from a client device, the server device can calculate a percentage of unique characters occurring in the text. In some examples of gibberish text, a user will repeatedly input the same keys on a keyboard. This can occur when a user holds down one key in an attempt to generate longer text with minimal effort. Using the fourth technique, the server device can utilize the percentage of unique characters to calculate a probability of gibberish of the text. Similar to the previous techniques, if the probability of gibberish satisfies a threshold amount, the server device can tag the online review as ingenuine to prevent the online review from being published.

It is noted that the techniques described herein can be used in isolation or in combination with other techniques implemented by the server device. In some embodiments, the techniques described herein can be used in machine learning algorithms for supervised learning. That is, a machine learning model can be trained on a set of techniques as described herein that effectively manages a high dimensionality problem and identifies a probability of gibberish text based on sentence structure or syntax, as opposed to the meaning of a sentence.

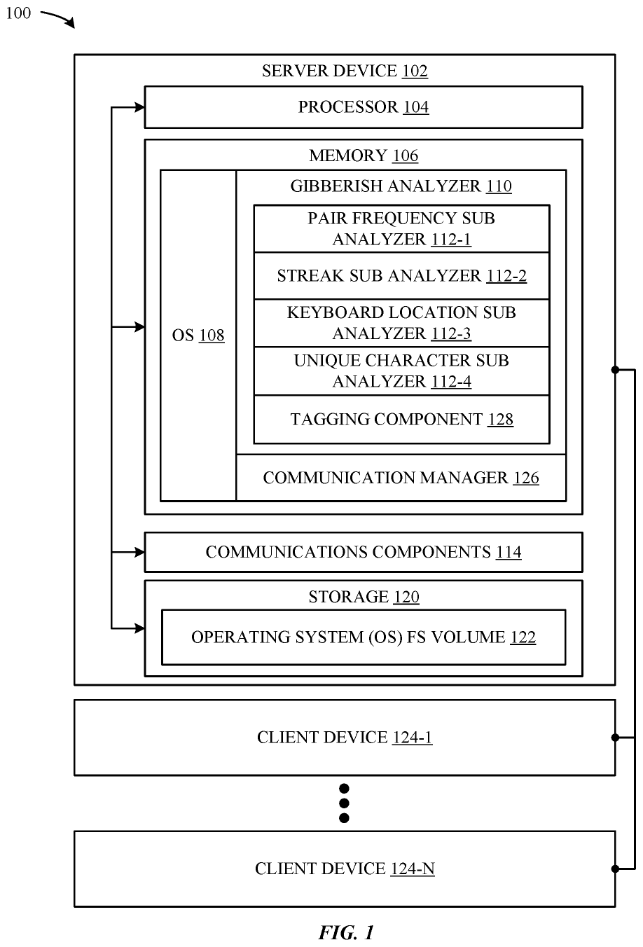

A more detailed discussion of these techniques is set forth below and described in conjunction with FIGS. 1, 2A-2F, 3A-3F, 4A-4F, 5A-5C, and 6, which illustrate detailed diagrams of systems and methods that can be used to implement these techniques.

FIG. 1 illustrates a block diagram 100 of a server device 102 and different client devices 124 that can be configured to implement various aspects of the techniques described herein, according to some embodiments. Specifically, FIG. 1 illustrates a high-level overview of a server device 102, which, as shown, can include at least one processor 104, at least one memory 106, and at least one storage 120 (e.g., a hard drive, a solid-state storage drive (SSD), etc.). According to some embodiments, the server device 102 can represent any form of a computing device, or network of computing devices, e.g., a personal computing device, a desktop computing device, a rack-mounted computing device, and so on. It is noted that the foregoing example computing devices are not meant to be limiting. On the contrary, the server device 102 can represent any form of computing device without departing from the scope of this disclosure.

According to some embodiments, the processor 104 can be configured to work in conjunction with the memory 106 and the storage 120 to enable the server device 102 to implement the various techniques set forth in this disclosure. According to some embodiments, the storage 120 can represent a storage that is accessible to the server device 102, e.g., a hard disk drive, a solid-state drive, a mass storage device, a remote storage device, and the like. For example, the storage 120 can be configured to store an operating system (OS) file system volume 122 that can be mounted at the server device 102, where the OS file system volume 122 includes an OS 108 that is compatible with the server device 102.

According to some embodiments, and as shown in FIG. 1, the OS 108 can enable a gibberish analyzer 110 to execute on the server device 102. It should be understood that the OS 108 can also enable a variety of other processes to execute on the server device 102, e.g., OS daemons, native OS applications, user applications, and the like. According to some embodiments, the gibberish analyzer 110 can be configured to implement sub analyzers 112 that enable the gibberish analyzer 110 to carry out the techniques described herein. In particular, the gibberish analyzer 110 can include a pair frequency sub analyzer 112-1, a streak sub analyzer 112-2, a keyboard location sub analyzer 112-3, a unique character sub analyzer 112-4, and a tagging component 128.

Each of the sub analyzers 112 can perform different techniques that enable the gibberish analyzer 110 to identify an ingenuine online review. An ingenuine online review, as used herein, refers to an online review that includes at least a review component that includes gibberish text. As previously described herein, such gibberish text typically exists in scenarios where it is easy to provide a rating component (e.g., selecting a star), but cumbersome to provide the review component (e.g., typing a narrative). In this regard, the review components of ingenuine online reviews are often completed in haste, e.g., where users input gibberish text on their keyboards simply to satisfy the criteria to submit the online review (e.g., a minimum number of characters). In this regard, the sub analyzers 112 can be configured to analyze the review component of a particular online review and determine a probability that the review component includes gibberish text. It is noted that the foregoing example sub-analyzers 112 are not meant to represent an exhaustive list in any manner, and that additional sub-analyzers 112 can be implemented as part of gibberish analyzer 110.

Additionally, as shown in FIG. 1, the OS 108 can also enable the execution of a communication manager 126. According to some embodiments, the communication manager 126 can interface with different communication components 114 that are included in the server device 102. The communications components 114 can include, for example, a WiFi interface, a Bluetooth interface, a Near Field Communication (NFC) interface, a cellular interface, an Ethernet interface, and so on. It is noted that these examples are not meant to represent an exhaustive list in any manner, and that any form of communication interface can be included in the communications components 114. According to some embodiments, the communications components 114 can also be configured to receive online reviews and provide them to the gibberish analyzer 110 for analysis.

For example—and as described in greater detail herein—the communication manager 126 can receive, via the communications components 114, an online review that includes a review component that includes text. In turn, the gibberish analyzer 110 can analyze the review component of the online review and determine a probability that an online review is ingenuine, which can be inferred when the gibberish analyzer 110 identifies gibberish text. The tagging component 128 of the gibberish analyzer 110 can then tag the online review to reflect whether the online review is genuine or ingenuine. According to some embodiments, the tagging scheme can include only tagging the genuine online reviews, tagging both genuine and ingenuine online reviews, or only tagging only ingenuine online reviews. It is noted that the tagging schemes described herein can be accomplished using a variety of techniques, including utilizing a Boolean value to indicate whether an online review is genuine or genuine, using a numerical value (e.g., “56”(%)) to indicate a probability that the online review is genuine, using a string value (e.g., “yes,” “likely,” “not likely,” “not”, etc.) to indicate a likelihood that the online review is genuine, and so on. It is noted that the foregoing examples are not meant to be limiting, and that any technique can be utilized to indicate an overall genuineness of an online review without departing from the scope of this disclosure. In any case, a recipient publisher can be configured to (automatically or manually) interpret the tags and publish the online reviews in accordance with their preferences.

According to some embodiments, and as shown in FIG. 1, the client devices 124 can be communicably coupled to the server device 102. Client devices 124 can represent any computing device that can be used to input text into the review component of an online review and submit the online review to the server device 102 for further processing. According to some embodiments, each client device 124 can represent any form of a computing device, e.g., a personal computing device, a desktop computing device, a rack-mounted computing device, a cellular phone or smart phone, a tablet computer, a laptop computer, a notebook computer, a personal computer, a netbook computer, a media player device, an electronic book device, a wearable computing device, and so on. It is noted that the foregoing example client devices 124 are not meant to represent an exhaustive list in any manner. On the contrary, the client devices 124 can represent any form of computing device without departing from the scope of this disclosure.

Although not illustrated in FIG. 1, each client device 124 can include one or more processors, one or more memories, one or more storage devices, and so on. These components can work in conjunction to enable the client devices 124 to transmit an online review to the server device 102. In one example, client device 124 can include a laptop computer through which a user types on a keyboard, a review component of an online review and submits the online review to server device 102 for further processing. According to some embodiments, a respective client device 124 can be communicably coupled to the server device 102 through any combination of wired and wireless connections including, e.g., Ethernet®, WiFi®, code division multiple access (CDMA), global system for mobile (GSM), and so on. It is noted, that the foregoing example methods of communication are not meant to represent an exhaustive list. On the contrary, communicative coupling between the client device 124 and the server device 102 can take any form without departing from the scope of this disclosure.

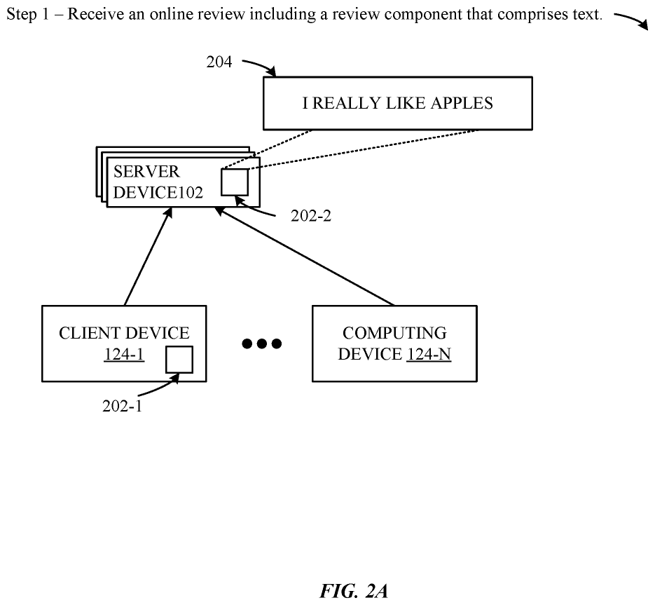

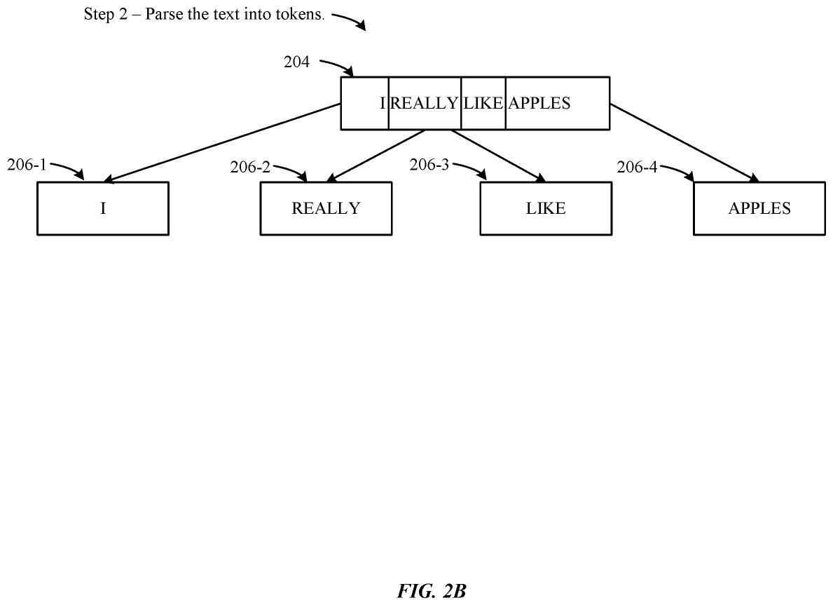

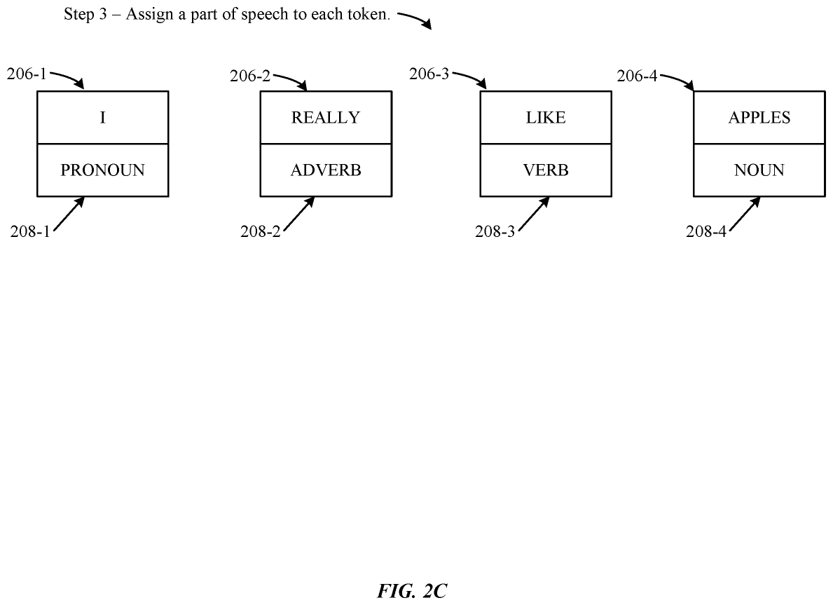

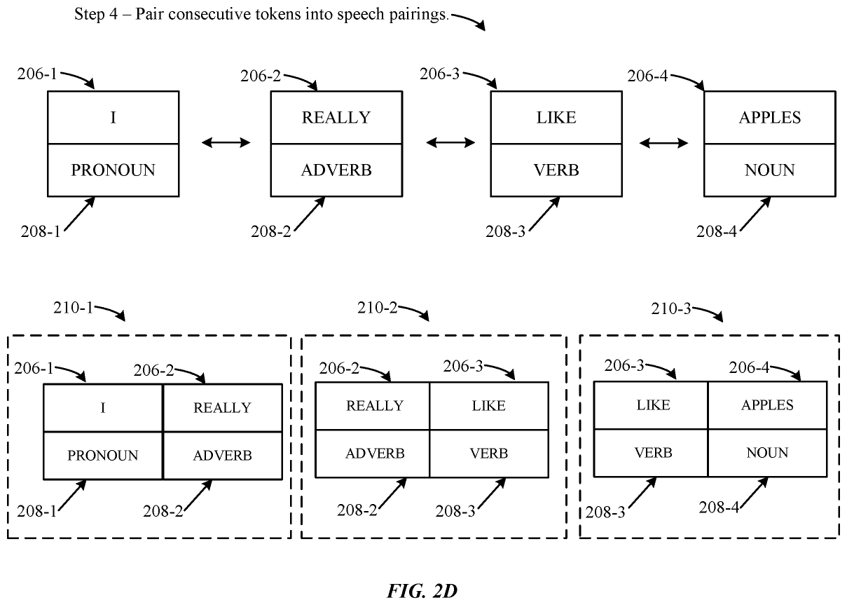

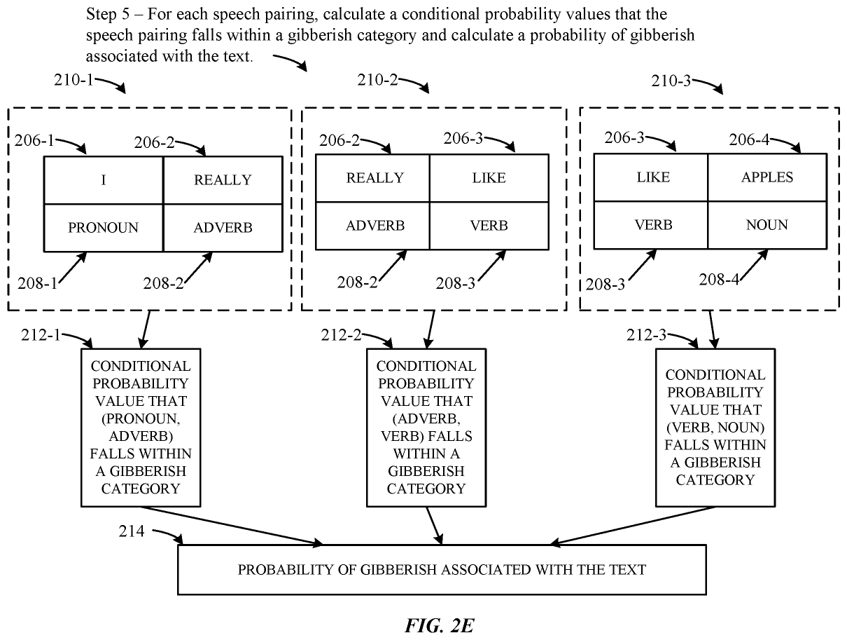

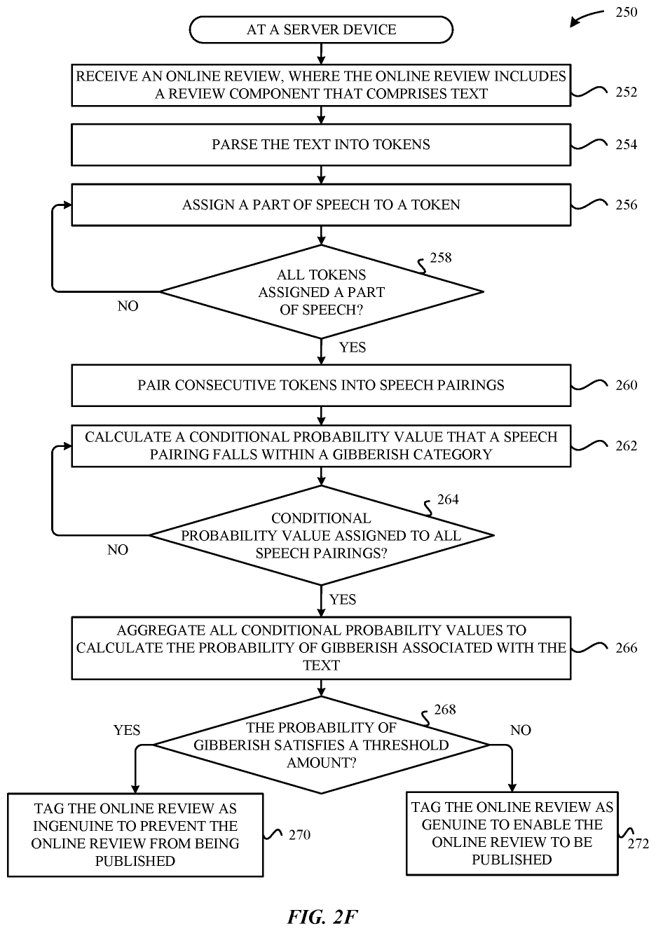

Accordingly, FIG. 1 sets forth a high-level overview of the different components that can be included in the server device 102 that enable the embodiments described herein to be properly implemented. These components can be utilized in a variety of ways to enable the server device 102 to identify ingenuine online reviews and filter the online reviews with regard to their publishing. In particular, FIGS. 2A-2F, 3A-3F, 4A-4F, and 5A-5C, set forth four example techniques respectively implemented by the four sub analyzers 112-(1-4) described herein, which will now be described below in greater detail.

FIGS. 2A-2F illustrate conceptual and method diagrams that demonstrate a technique that can be implemented by pair frequency sub analyzer 112-1. As shown in FIG. 2A, a first step of an example scenario can involve a client device 124-1 providing an online review 202-1 to the server device 102. According to some embodiments, included in the online review 202-1 is a review component that includes text. As shown in FIG. 2A, the server device 102 receives the online review 202-1 as online review 202-2, where the online review 202-2 includes the text 204 having the value “I REALLY LIKE APPLES.” Notably, although only the review component of the online review 202-2 is shown in FIG. 2A, it should be understood that the online review 202-2 can include other components not shown such as a rating component and so on.

Next at FIG. 2B, and in response to receiving the online review, the server device 102 can utilize the pair frequency sub analyzer 112-1 (introduced in FIG. 1) to parse the text 204 into smaller units referred to herein as “tokens.” In some embodiments, a token can include one character or several characters that represent a full concept. That is, a full concept can be read in isolation and have an abstract or objective meaning. For example, a full concept such as the word “apple,” when written in Chinese can include two Chinese characters. In this example, the token includes the two Chinese characters that represent the full concept “apple.” In other embodiments, a token can be defined as any group of letters or characters delimited by a space. For example, a word written in English, Spanish, German, and the like can be a token. It is noted that the foregoing examples of how a token is defined is not meant to be limiting. On the contrary, parsing the text into smaller units defining tokens can take any form without departing from the scope of this disclosure.

As shown in FIG. 2B, the text 204 having the value “I REALLY LIKE APPLES” is parsed into four tokens 206. The token 206-1 has the value “I”, the token 206-2 has the value “REALLY”, token 206-3 has the value “LIKE”, and token 206-4 has the value “APPLES”. Next, at step 3 of FIG. 2C, and in response to the parsing, the pair frequency sub analyzer 112-1 assigns a part of speech 208 to each token. A part of speech can be a category of words or lexical items that have similar grammatical properties. Words within the same part of speech category play similar roles within the grammatical structure of a sentence, and part of speech categories can include noun, verb, adverb, pronoun, preposition, conjunction, and the like. It is noted that the foregoing part of speech examples are not meant to be an exhaustive list. As shown in FIG. 2C, the pair frequency sub analyzer 112-1 assigns the part of speech value of “pronoun” (208-1), to the token with the value “I” (206-1), the part of speech value of “adverb” (208-2) to the token with the value “REALLY” (206-2), the part of speech value of “verb” (208-3) to the token with the value “LIKE” (206-3), and the part of speech value of “noun” (208-4) to the token with the value “APPLES” (206-4).

Next, at step 4 of FIG. 2D, and in response to assigning a part of speech value to each of the tokens 206, the pair frequency sub analyzer 112-1 pairs consecutive tokens and respective parts of speech values into speech pairings. Two tokens are considered to be consecutive if they appear next to each other in the text (e.g., the text 204 in FIG. 2A). In the example text 204, the following tokens can be considered consecutive: the tokens with the values “I” (206-1) and “REALLY” (206-2); the tokens with the values “REALLY” and “LIKE” (206-3); and the tokens with the values “LIKE” (206-3) and “APPLES” (206-4). Accordingly, in this example, three speech pairings 210 are formed. As shown in FIG. 2D, the speech pairing 210-1 includes the tokens with the values “I” (206-1) and “REALLY” (206-2) and the respective parts of speech values pronoun (208-1) and adverb (208-2). The speech pairing 210-2 includes the tokens with the values “REALLY” (206-2) and “LIKE” (206-3) and the respective parts of speech values adverb (208-2) and verb (208-3). The speech pairing 210-3 includes the tokens “LIKE” (206-3) and “APPLES” (206-4) and the respective parts of speech values verb (208-3) and noun (208-4). To further clarify, after step 4, a speech pairing includes two parts of speech, e.g., (pronoun, adverb), (adverb, verb), or (verb, noun), and the like.

It is noted that the foregoing example in which two tokens are paired is not meant to be a limiting example. On the contrary, any number of tokens can be grouped to form a grouping without departing from the scope of this disclosure. For example, a grouping of tokens can include three consecutive tokens, and so on. Further, a grouping of tokens can include tokens that are not consecutive to each other.

Next, at step 5 of FIG. 2E, and in response to creating the speech pairings, the pair frequency sub analyzer 112-1 calculates, for each of the speech pairings 210, a conditional probability value 212 that the speech pairing falls within a gibberish category. The conditional probability value 212 associated with each speech pairing can eventually be used to calculate an overall probability of gibberish associated with the text 204.

Next, the speech pairing (pronoun, adverb) (210-1) is used in one example to demonstrate how a conditional probability value 212 associated with the speech pairing (pronoun, adverb) (210-1) is calculated. In this example, the pair frequency sub analyzer 112-1 is configured to calculate the conditional probability value 212 that the speech pairing (pronoun, adverb) (210-1) falls within a gibberish category, using the following equation (1),

$$Pr ( gib \text{\textbar} POSpair ) = \frac{Pr ( POSpair \text{\textbar} gib )}{Pr ( POSpair \text{\textbar} gib ) + Pr ( POSpair \text{\textbar} non - gib )} \qquad ( 1 )$$

where Pr(POSpair|gib) is the conditional probability that a particular part of speech pairing (“POSpair”) occurs within a text known to be gibberish (“gib”) or ingenuine. Or in other words, given that a text is known to be gibberish, the probability of the particular part of speech occurring within the text. Additionally, Pr(POSpair|non-gib) is the conditional probability that a particular part of speech pairing occurs within a text known to be non-gibberish (“non-gib”). Or in other words, given that a text is known to be non-gibberish, the probability of the particular part of speech occurring with the text.

In the example using the speech pairing (pronoun, adverb) (210-1), the conditional probabilities would include the conditional probability that the speech pairing (pronoun, adverb) (210-1) occurs when a given text is known to be gibberish, and the conditional probability that the speech pairing (pronoun, adverb) (210-1) occurs when a given text is known to be non-gibberish. In some embodiments, the conditional probabilities may be calculated prior to calculating equation (1) from labeled training data. For example, a user can label multiple sample texts as gibberish and non-gibberish based on whether the text is gibberish or non-gibberish to create labeled training data. The labeled training data can then be analyzed by a machine or computing device to determine the above discussed conditional probability values.

Certain types of speech pairings can occur more frequently in text that is non-gibberish because non-gibberish text tends to follow grammatical rules, where the non-gibberish text has some structure within sentences. In contrast, gibberish text does not follow grammatical rules. Accordingly, the pair frequency sub analyzer 112-1 utilizes knowledge of the probabilities of each part of speech pairing appearing in non-gibberish text to assess whether the text 204 is gibberish. For example, if the text 204 contains more types of part of speech pairings that frequently occur in non-gibberish text, the likelihood that the text 204 is non-gibberish is higher than if the text 204 lacks the types of speech pairings that frequently occur in non-gibberish text.

In particular, the Bayesian inference allows the pair frequency sub analyzer 112-1 to calculate a probability that the text 204 is gibberish based on the probabilities of a part of speech pairing previously occurring in non-gibberish text and gibberish text. The pair frequency sub analyzer 112-1 leverages the Bayesian inference by utilizing the statistical probabilities of the part of speech pairings appearing in gibberish and non-gibberish training data in equation (1), wherein equation (1) reflects an equal probability of occurrence of both gibberish and non-gibberish reviews. Continuing the example of the speech pairing (pronoun, adverb) (210-1), the output of equation (1) is the probability that the speech pairing 210-1 appears in gibberish text or falls within a gibberish category.

In FIG. 2E, the pair frequency sub analyzer 112-1 uses equation (1), to determine the individual conditional probability values 212 for each of the speech pairings 210. Each of the conditional probability values 212 represents a conditional probability value that a respective speech pairing 210 falls within a gibberish category. In particular, the pair frequency sub analyzer 112-1 calculates a conditional probability value 212-1 that the speech pairing (pronoun, adverb) (210-1) falls within a gibberish category, a conditional probability value 212-2 that the speech pairing (adverb, verb) (210-2) falls within a gibberish category, and a conditional probability value 212-3 that the speech pairing (verb, noun) (210-3) falls within a gibberish category.

As also illustrated in FIG. 2E, in response to calculating the individual conditional probabilities values 212, the pair frequency sub analyzer 112-1 aggregates the individual conditional probabilities values 212 to calculate the probability of gibberish associated with the text 204 (214) using the following equation (2),

$$Pr ( gib \text{\textbar} AllPOSpairs ) = \frac{{Π}_{i = 0}^{n} Pr ( gib \text{\textbar} {POSpair}_{i} )}{{Π}_{i = 0}^{n} Pr ( gib \text{\textbar} {POSpair}_{i} ) + {Π}_{i = 0}^{n} ( 1 - Pr ( gib \text{\textbar} {POSpair}_{i} ) )} \qquad ( 2 )$$

where Pr(gib|POSpair) is the output of equation (1). Continuing the example using the speech pairing (pronoun, adverb) (210-1), the output of equation (2) (214) represents the probability that the text 204 is gibberish given all the types of the part of speech pairings present in the text 204, e.g., the speech pairings (pronoun, adverb) (210-1), (adverb, verb) (210-2), and (verb, noun) (210-3).

Accordingly, FIGS. 2A-2E illustrate an example breakdown of the manner in which the pair frequency sub analyzer 112-1 can calculate a probability of gibberish associated with text. In turn, the gibberish analyzer 110 can use the calculated probability of gibberish associated with the text to identify an ingenuine online review, where the ingenuine online review can subsequently be prevented from publishing. Additional high-level details will now be provided below in conjunction with FIG. 2F, which illustrates a method 250 that can be implemented to carry out the techniques described above in conjunction with FIGS. 2A-2E. As shown in FIG. 2F, the method 250 begins at step 252, the server device 102 receives an online review, where the online review includes a review component that includes text (e.g., as described above in conjunction with FIG. 2A).

At step 254, the server device 102 parses the text into tokens (e.g., as described above in conjunction with FIG. 2B). At step 256, the server device 102 assigns a part of speech to a token (e.g., as described above in conjunction with FIG. 2C). As decision block 258, the server device 102 checks if all tokens have been assigned a part of speech. If no, the server device 102 performs steps 256 and assigns a part of speech to another token. Accordingly, the server device 102 assigns a part of speech to each token (e.g., as described above in conjunction with FIG. 2C). Once the server device 102 assigns a part of speech to all tokens, at step 260, the server device 102 pairs consecutive tokens into speech pairings (e.g., as described above in conjunction with FIG. 2D).

At step 262, the server device 102 calculates a conditional probability value that a speech pairing falls within a gibberish category (e.g., as described above in conjunction with FIG. 2E). At decision block 264, the server device 102 checks if conditional probability values have been assigned to all speech pairings. If no, the server device 102 performs step 262 and calculates a conditional probability value that another speech pairing falls within the gibberish category. Accordingly, the server device 102 calculates conditional probability values for all speech pairings (e.g., as described above in conjunction with FIG. 2E). Once the server device 102 calculates the conditional probability values for all speech pairings, at step 266, the server device 102 aggregates all conditional probability values to calculate the probability of gibberish associated with the text (e.g., as also described above in conjunction with FIG. 2E).

Next, at decision block 268, the server device 102 utilizes the probability of gibberish associated with the text to make a determination as to whether the online review is genuine or ingenuine. For example, if the probability of gibberish satisfies a threshold amount, at step 270, the server device 102 tags the online review 202-2 as ingenuine to prevent the online review 202-2 from being published. If the probability of gibberish does not satisfy the threshold amount, at step 272, the server device 102 tags the online review 202-2 as genuine to enable the online review 202-2 to be published.

Accordingly, FIGS. 2A-2F illustrate a manner in which the pair frequency sub analyzer 112-1 implemented within the gibberish analyzer 110 of the server device 102 calculates a probability of gibberish associated with a text of a review component of an online review. The server device 102 parses text into tokens, determines the types of part of speech pairings that occur in the text, and utilizes previous knowledge of the types of part of speech pairings that occur in non-gibberish text to determine a probability of gibberish of the text. As previously described herein, the server device 102 utilizes the probability of gibberish to separate online reviews that are genuine from online reviews that are ingenuine and can prevent ingenuine online reviews from publishing. In other examples, ingenuine reviews can be returned to the users who submit them, with requests to update their reviews to make them genuine. By using at least this first technique to filter ingenuine online reviews, the server device 102 enhances the overall user experience by reducing the number of ingenuine online reviews by which a prospective patron can potentially be misled. To assess the probability of gibberish, the gibberish analyzer 110 can use the technique described in FIGS. 2A-2F in isolation or in combination with other techniques implemented by other sub analyzers implemented within the gibberish analyzer 110.

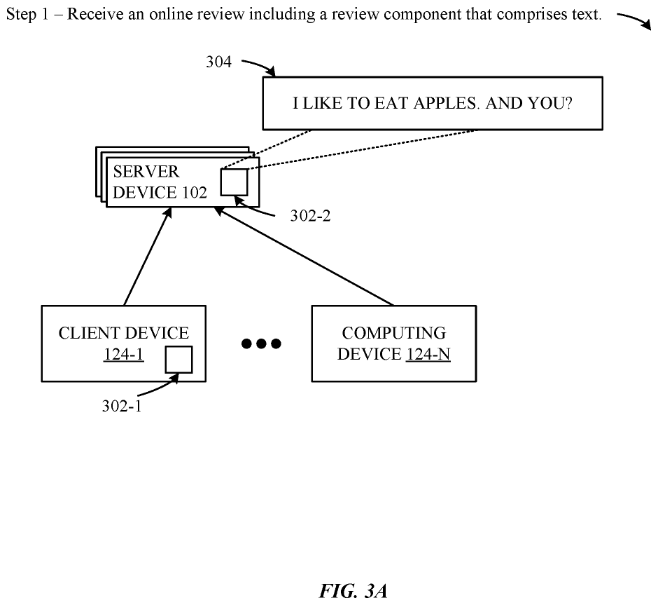

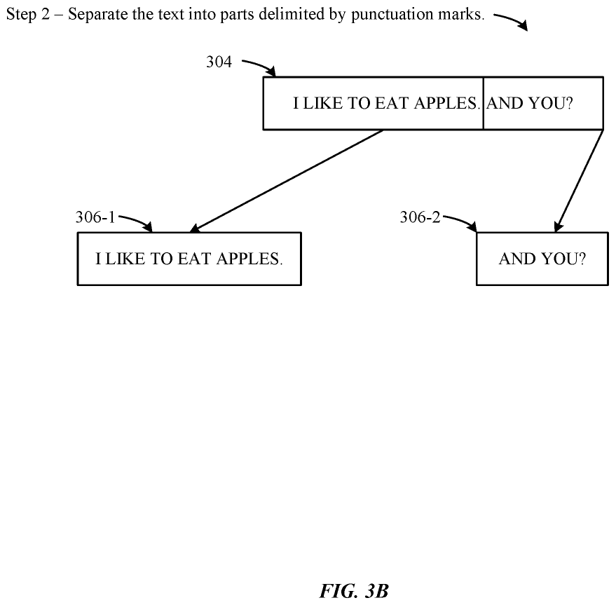

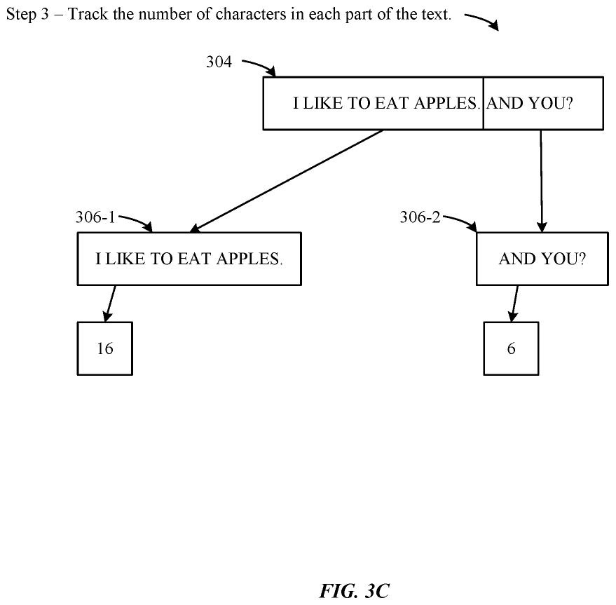

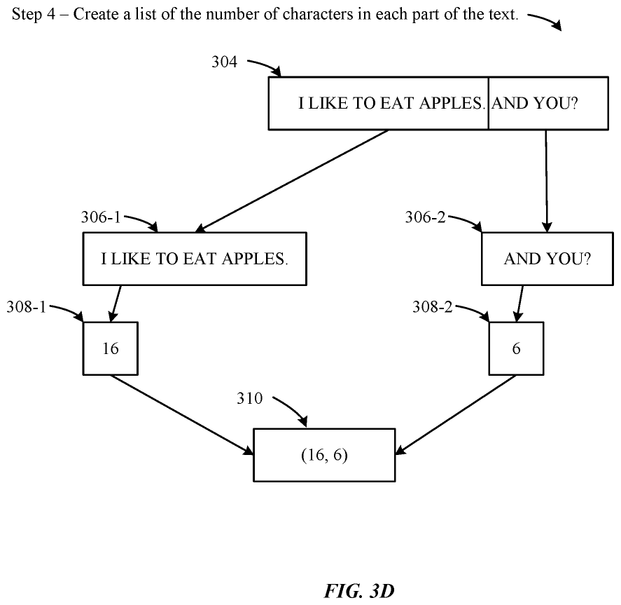

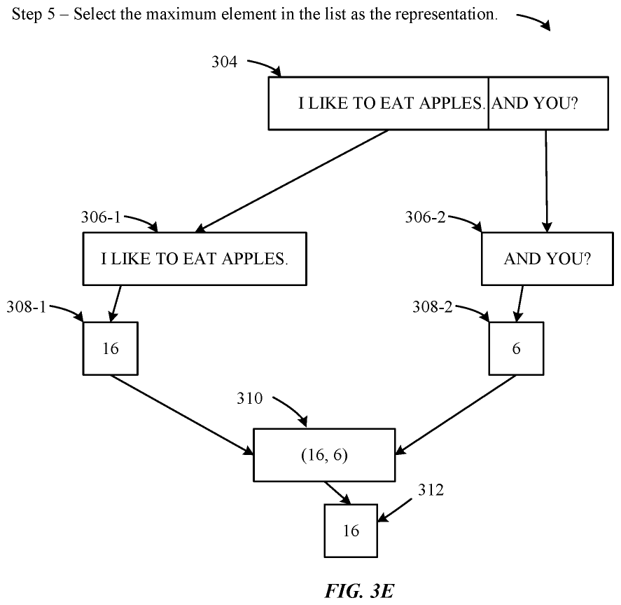

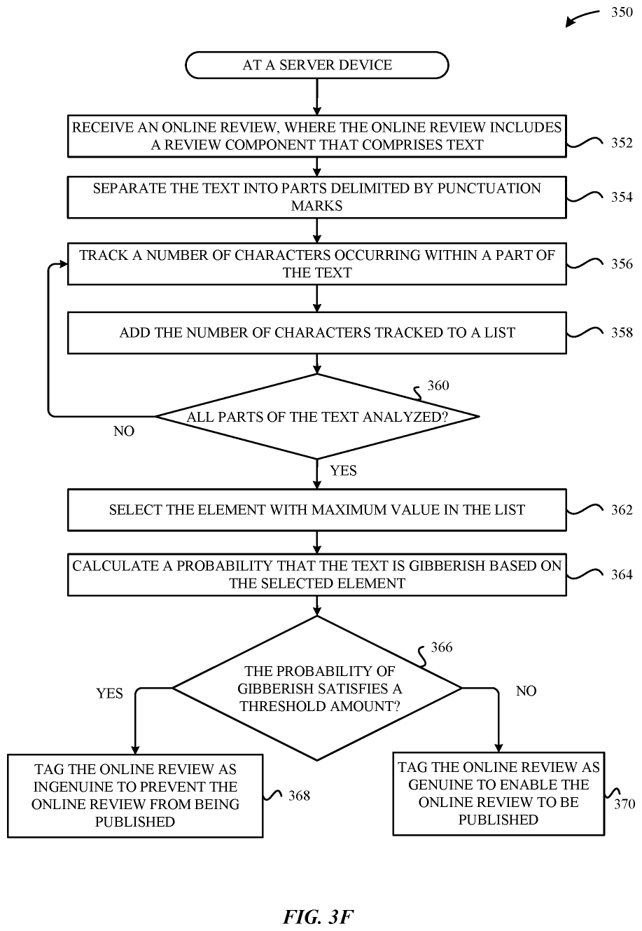

In particular, FIGS. 3A-3F illustrate conceptual and method diagrams that demonstrate the manner in which a streak sub-analyzer 112-2 can further analyze the text of a review component of an online review. Similar to the technique described in FIGS. 2A-2F, as shown in FIG. 3A, initially a client device 124-1 provides an online review 302-1 to the server device 102. The server device 102 receives the online review as an online review 302-2, and the online review 302-2 includes the text 304 having the value “I LIKE TO EAT APPLES. AND YOU?” Notably, although only the review component of the online review 302-2 is shown in FIG. 3A, it should be understood that the online review 302-2 can include other components not shown such as a rating component and so on. Additionally, although characters including Roman letters are shown in the text 304, it is noted that characters can include letters, logograms (e.g., as used in Chinese), numerical digits, punctuation marks, and other individual symbols.

Next, at FIG. 3B, and in response to receiving the online review 302-2, the server device 102 can utilize the streak sub analyzer 112-2 (introduced in FIG. 1) to separate the text 304 into parts delimited by punctuation marks. As shown in FIG. 2B, the text 304 having the value “I LIKE TO EAT APPLES. AND YOU?” is parsed into two parts 306-1 and 306-2. In this example, the period between the value “APPLES” and “AND” serves as the first delimiter, while the question mark after the value “YOU” serves as a second delimiter. Thus, in this example, the value of text 304 is separated into two parts, where each part contains a number of characters.

At FIG. 3C, and in response to the separating, in step 3, the streak sub analyzer 112-2 tracks the number of characters that is not a punctuation mark, present within each part (306-1 and 306-2) of the text 304. It is noted that various methods can be used the track the number of characters not including punctuation marks. The following example for tracking the number of characters is not meant to be limiting. On the contrary, tracking the number of characters can take any form without departing from the scope of this disclosure.

For example, to track the number of characters that is not a punctuation mark in each part (306-1 and 306-2), a counter can be set to an initial value, such as zero. Although zero is used in this example, the counter can be set to other initial values such as −5, 20, 0.5, and the like. Additionally, the streak sub analyzer 112-2 can set a pointer at an initial position within part 306-1, where the pointer progressively moves in a given direction while the counter is incremented or decremented each time the pointer moves and encounters a character that is not a punctuation mark. For purposes of this disclosure, the term “advance” as pertaining to a counter includes both incrementing and decrementing the counter. Upon encountering a punctuation mark, the counter is reset to the initial value. Additionally, the initial position can be predefined to be at any position within the part (e.g., at the first character within the part, at the second character within the part, and the like.)

Thus, continuing the example where the counter is set to an initial value of zero, the streak sub analyzer 112-2 can set the pointer at the first character within the part 306-1 (e.g., at “I”) and while progressively moving the pointer to the next character present within the part 306-1 (e.g., move to “L,” “I,” “K,” and the like), advance the counter. Upon encountering the punctuation mark of a period, the streak sub-analyzer 112-2 resets the counter to the initial value of zero. Thus, the streak sub-analyzer 112-2 can count the number of characters present within the part 306-1 as 16, and the number of characters present within the part 306-2 as 6. Again, this example is not meant to be limiting and on the contrary, tracking the number of characters can take any form without departing from the scope of this disclosure.

Next, as illustrated in FIG. 3D, an in response to tracking the number of characters, in step 4, the streak sub-analyzer 112-2 creates a list 310 of the number of characters counted in each part (e.g., 306-1 and 306-2) of the text 304. Although in this example, the streak sub-analyzer 112-2 is shown to create the list in a subsequent step 4, it is noted that the creation of the list can occur around the same time that the streak sub-analyzer 112-2 tracks the number of characters within each part of the text 304. Thus, the order in which the characters are tracked and the list is created is not meant to be limiting and tracking the number of characters can take any form without departing from the scope of this disclosure.

As the text 304, in this example, includes two parts, the list 310 includes two elements “16” and “6”. It is noted, the size of the list 310 will depend on the number of parts included in a text, such as text 304. That is, for every part in a text, the list 310 will include an element representing the number of characters counted in the respective part. Next, as illustrated in FIG. 3E, and in response to creating the list 310, in step 5, the streak sub-analyzer 112-2 selects the maximum element in the list 310 as the representation 312.

Accordingly, FIGS. 3A-3E illustrate an example breakdown of the manner in which the streak sub analyzer can identify the longest string of characters present in the text 304 delimited by a punctuation mark (the value of representation 312). In turn, the gibberish analyzer 110 can use the value of the representation 312 in isolation or in conjunctions with other factors to identify an ingenuine online review, where the ingenuine online review is subsequently prevented from publishing. Additional high-level details will now be provided below in conjunction with FIG. 3F, which illustrates a method 350 that can be implemented to carry out the techniques described above in conjunction with FIGS. 3A-3E. As shown in FIG. 3F, the method 350 begins at step 352, the server device 102 receives an online review, where the online review includes a review component that includes the text 304 (e.g., as described above in conjunction with FIG. 3A).

At step 354, the server device 102 separates the text 304 into parts delimited by punctuation marks (e.g., as described above in conjunction with FIG. 3B). At step 356, the server device 102 tracks a number of characters occurring with a part of the text 304 (e.g., as described above in conjunction with FIG. 3C). At step 358, the server device 102 add the number of characters tracked to a list 310 (e.g., as described above in conjunction with FIG. 3D). At decision block 360, the server device 102 check if all parts of the text 304 have been analyzed. If not, the server device 102 repeats steps 356 and 358. Accordingly, the server device 102 tracks the number of characters in each part of the text 304 and records each tracked number of characters in the list 310, where the list 310 stores a number of characters tracked as an element in the list 310.

Once the server device 102 analyzes all parts of the text 304, at step 362, the server device 102 selects the element with the maximum value from the list 310. Next, at step 364, the server device 102 calculates a probability that the text 304 is gibberish based on the selected element from the list 310. For example, the larger the value of the selected element from the list 310, the larger the probability that the text 304 is gibberish. Next, at decision block 366, the server device 102 utilizes the probability of gibberish associated with the text to make a determination as to whether the online review is genuine or ingenuine. For example, if the probability of gibberish satisfies a threshold amount, at step 368, the server device 102 tags the online review 302-2 as ingenuine to prevent the online review 302-2 from being published. If the probability of gibberish does not satisfy the threshold amount, at step 370, the server device 102 tags the online review 302-2 as genuine to enable the online review 302-2 to be published.

Accordingly, FIGS. 3A-3F illustrate a manner in which the streak sub analyzer 112-2 implemented within the gibberish analyzer 110 of the server device 102 can use an additional technique to calculate a probability of gibberish associated with a text of a review component of an online review. The server device 102 separates the text into parts and determines the largest streak of characters without punctuation marks present in the text. This information regarding the largest streak of characters within punctuations marks present in the text can be used to determine a probability of gibberish of the text.

As previously described herein, the server device 102 utilizes the probability of gibberish to separate online reviews that are genuine from online reviews that are ingenuine and can prevent ingenuine online reviews from publishing. By using at least this second technique to filter ingenuine online reviews, the server device 102 enhances the overall user experience by reducing the number of ingenuine online reviews by which a prospective patron can potentially be misled. To assess the probability of gibberish, the gibberish analyzer 110 can use the technique described in FIGS. 3A-3F in isolation or in combination with other techniques implemented by other sub analyzers implemented within the gibberish analyzer 110.

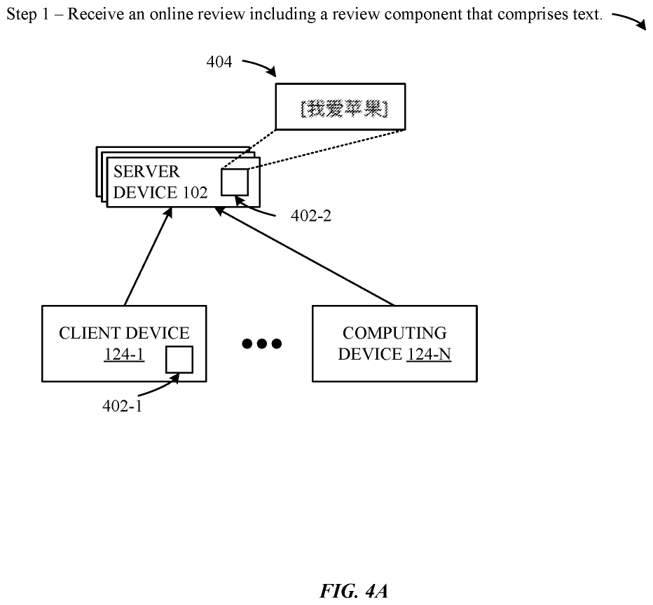

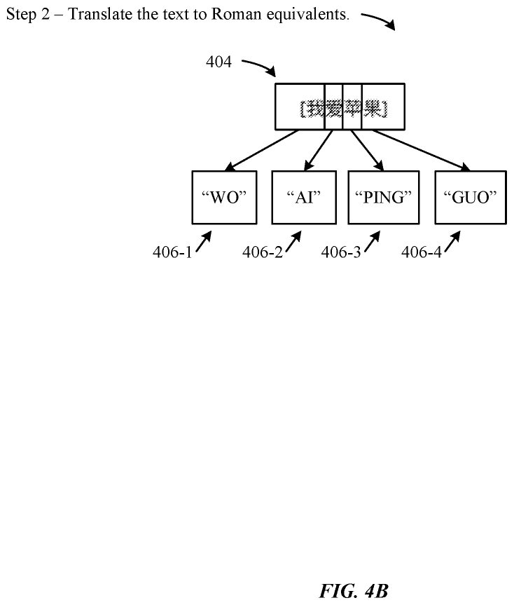

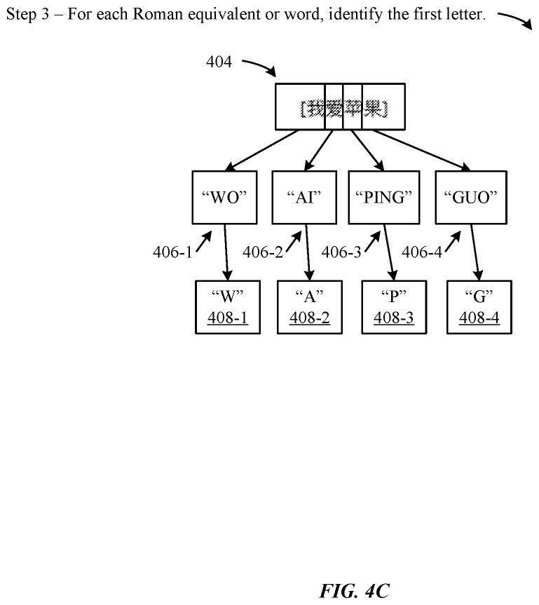

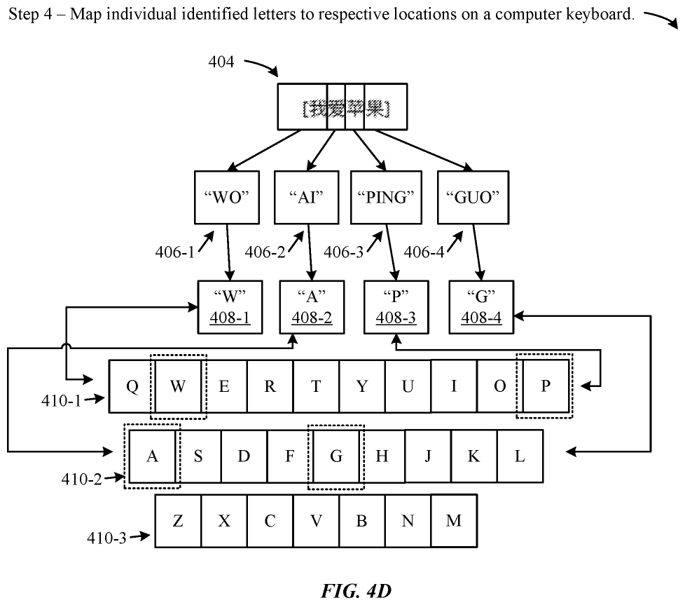

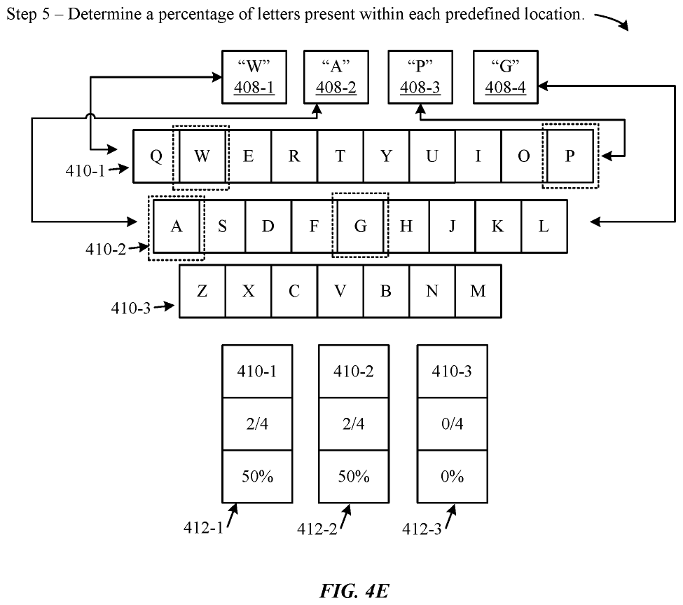

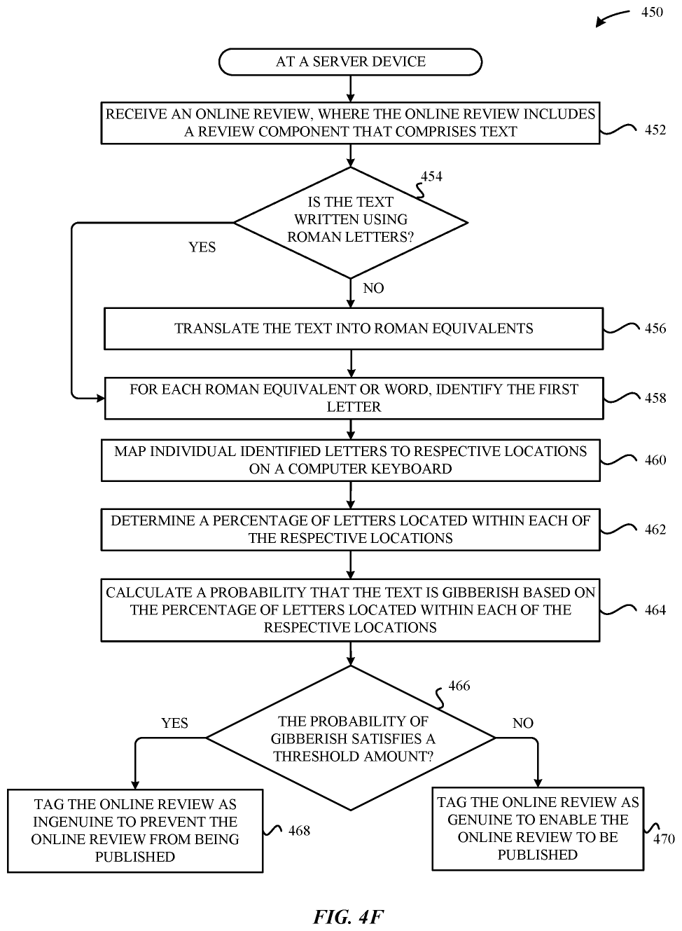

In particular, FIGS. 4A-4F illustrate conceptual and method diagrams that demonstrate the manner in which a keyboard location sub analyzer 112-3 (introduced in FIG. 1) can further analyze the text of a review component of an online review. The keyboard location sub analyzer 112-3 can calculate a percentage of characters originating at particular parts of a keyboard. The location on a keyboard from which characters in a text originate can be associated with a probability that the text is gibberish. In some examples of gibberish text, a user will repeatedly input keys from the same row on a keyboard. Accordingly, the percentage of characters originating at particular parts of a keyboard can be used to calculate a probability of gibberish of the text.

Similar to the techniques described in FIGS. 2A-2F and FIGS. 3A-3F, as shown in FIG. 4A, initially a client device 124-1 provides an online review 402-1 to the server device 102. The server device 102 receives the online review 402-1 as an online review 402-2, and the online review 402-2 includes the text 404 having the value:

$$( 3 )$$

Notably, the text 404 includes text written in Chinese characters. Additionally, although only the review component of the online review 402-2 is shown in FIG. 4A, it should be understood that the online review 402-2 can include other components not shown such as a rating component and so on. Additionally, although Chinese characters are shown in the text 404, it is noted that the text 404 can include alphabetic letters, logograms, numerical digits, punctuation mark, and other individual symbols.

Next, at FIG. 4B, and in response to receiving the online review 402-2, the server device 102 can utilize the keyboard location sub analyzer 112-3 (introduced in FIG. 1) to translate the text 404 to Roman equivalents. That is, the keyboard location sub analyzer 112-3 can recognize that the text 404 does not include Roman letters and, in response to recognizing the text 404 does not include Roman letter, translate the text 404 to include Roman letters. In the example illustrated in FIG. 4B, the text 404 which includes Chinese characters is translated to Hanyu Pinyin equivalents, the official Romanization system for Standard Chinese in mainland China.

For example, the Chinese character:

$$( 4 )$$

is translated to a Roman equivalent 406-1, particularly the Hanyu Pinyin equivalent with a value “WO.” The keyboard location sub analyzer 112-3 translates the remaining Chinese characters in text 404 to the respective Roman equivalents, more particularly the Hanyu Pinyin equivalent with values “AI” (406-2), “PING” (406-3), and “GUO” (406-4). It is noted that the foregoing example of how the text 404 is translated is not meant to be limiting. On the contrary, translating the text 404 when the text does not include Roman letters can take any form without departing from the scope of this disclosure. Additionally, when the keyboard location sub analyzer 112-3 analyzes text that includes Roman letters, the keyboard location sub analyzer 112-3 can skip this translation step (step 2) and proceed to performing step 3, discussed below.

Next, as illustrated in FIG. 4C, and in response to translating the text 404, in step 3, the keyboard location sub analyzer 112-3 identifies the first letter in each of the Roman equivalents 406-1, 406-2, 406-3, and 406-4. For example, for the Roman equivalent 406-1 with the value “WO,” the keyboard location sub analyzer 112-3 identifies the letter 408-1 with a value “W”. Similarly, for the Roman equivalent 406-2 with the value “AI,” the keyboard location sub analyzer 112-3 identifies the letter 408-2 with a value “A, for the Roman equivalent 406-3 with the value “PING,” the keyboard location sub analyzer 112-3 identifies the letter 408-3 with the value “A,” and for the Roman equivalent 406-4 with the value “GUO,” the keyboard location sub analyzer 112-3 identifies the letter 408-4 with the value “G.” It is noted that the foregoing example of identifying a letter within each Roman equivalent is not meant to be limiting. For example, on the contrary, any letter within any position of the Roman equivalent can be identified in place of the identified letters.

Next, as illustrated in FIG. 4D, and in response to identifying the first letter, in step 4, the keyboard location sub analyzer 112-3, maps the individual identified letters 408 to respective locations on a computer keyboard. In FIG. 4D, representations of the three rows of a keyboard with a QWERTY keyboard design is shown. The keys of the keyboard can be grouped into predefined locations of the keyboard using any methodology to group the keys of the keyboard.

For example, the predefined location 410-1 includes keys present in a top row of the QWERTY keyboard, the predefined location 410-2 includes keys present in the middle row of the QWERTY keyboard, and the predefined location 410-3 includes keys present in the bottom row of the QWERTY keyboard. It is noted that the foregoing example of a keyboard with a QWERTY design is not meant to be limiting, nor is the manner in which the keys are grouped meant to be limiting. On the contrary, the computer keyboard can take any form implementing any design without departing from the scope of this disclosure. Similarly, the keys on the keyboard can be grouped using any scheme without departing from the scope of this disclosure.

Given the example identified first letters 408, the keyboard location sub analyzer maps the identified letters 408 to the first and second predefined locations 410-1 and 410-2. In particular, the letter 408-1 with the value “W” and the letter 408-3 with the value “P” are mapped to the predefined location 410-1. And the letter 408-2 with the value “A,” and the letter 408-4 with the value “G” are mapped to the predefined location 410-1. In this example, none of the letters 408 occur in the predefined location 410-3.

Next, as illustrated in FIG. 4E, and in response to mapping the identified letters, in step 5, the keyboard location sub analyzer 112-3 determines a percentage of letters present within each predefined location 410 of the keyboard. For example, the keyboard location sub analyzer 112-3 can determine that of the four identified letters 408, two letters (408-1 and 408-3) are located in predefined location 410-1. Accordingly, keyboard location sub analyzer 112-3 calculates the percentage 412-1 (50%) of letters occurring in predefined location 410-1. The keyboard location sub analyzer 112-3 can determine that two letters (408-1 and 408-3) of the four are located in predefined location 410-2. Accordingly, the keyboard location sub analyzer 112-3 calculates the percentage 412-2 (50%) of letters occurring in predefined location 410-2. Finally, no letters of the four letters 408 occur in the predefined location 410-3. Accordingly, the keyboard location sub analyzer calculates the percentage 412-3 (0%) or letters occurring in the predefined location 410-3.

Accordingly, FIGS. 4A-4F illustrate an example breakdown of the manner in which the keyboard location sub analyzer 112-3 can calculate a percentage of identified letters located in predetermined locations of a computer keyboard. In turn, the gibberish analyzer 110 can use the calculated percentages to identify an ingenuine online review, where the ingenuine online review is subsequently prevented from publishing. Additional high-level details will now be provided below in conjunction with FIG. 4F, which illustrates a method 450 that can be implemented to carry out the technique described above in conjunction with FIGS. 4A-4E. As shown in FIG. 4F, the method 450 begins at step 452, where the server device 102 receives an online review, where the online review includes a review component that includes the text 404 (e.g., as described above in conjunction with FIG. 4A).

At decision block 454, the server device 102 checks if the text is written using Roman letters. If no, the server device 102 performs step 456 and translates the text 404 into Roman equivalents (e.g., as described above in conjunction with FIG. 4B). If yes, the server device 102 skips step 456 and performs step 458. In the event that step 456 is performed, the server device 102 also performs step 458. At step 458, the server device 102 identifies the first letter for each Roman equivalent or word (e.g., as described in conjunction with FIG. 4C). In the example where the received text was translated to Roman equivalents, the server device 102 identifies the first letter for each Roman equivalent. In another example where the received text included Roman letters, the server device 102 identifies the first letter for each word.

At step 460, the server device 102 maps individual identified letters to respective locations on a computer keyboard (e.g., as described in conjunction with FIG. 4D). At step 462, the server device 102 determines a percentage of letters located within each of the respective locations (e.g., as described in conjunction with FIG. 4D). Next, at step 464, the server device 102 calculates a probability that the text 404 is gibberish based on the percentage of letters located within each of the respective locations. For example, if one predefined location has a percentage of letters higher than a predefined threshold amount, then a probability that the text 404 is gibberish may be higher.

Next, at decision block 466, the server device 102 utilizes the probability of gibberish associated with the text 404 to make a determination as to whether the online review is genuine or ingenuine. For example, if the probability of gibberish satisfies a threshold amount, at step 468, the server device 102 tags the online review 402-2 as ingenuine to prevent the online review 402-2 from being published. If the probability of gibberish does not satisfy the threshold amount, at step 470, the server device 102 tags the online review 402-2 as genuine to enable the online review 402-2 to be published.

Accordingly, FIGS. 4A-4F illustrate a manner in which the keyboard location sub analyzer 112-3 implemented within the gibberish analyzer 110 of the server device 102 can use an additional technique to calculate the probability of gibberish associated with a text of a review component of an online review. The server device 102 translates text that does not include Roman letters to Roman equivalents and then maps identified letters from the equivalents to computer keyboard. Subsequently, the server device 102 can calculate a percentage of letters occurring in predefined locations of the keyboard. This information regarding the percentage of letters occurring in predefined locations of the keyboard can be used to determine a probability of gibberish of the text.

As previously described herein, the server device 102 utilizes the probability of gibberish to separate online reviews that are genuine from online reviews that are ingenuine and can prevent ingenuine online reviews from publishing. By using at least this third technique to filter ingenuine online reviews, the server device 102 enhances the overall user experience by reducing the number of ingenuine online reviews by which a prospective patron can potentially be misled. To assess the probability of gibberish, the gibberish analyzer 110 can use the technique described in FIGS. 4A-4F in isolation or in combination with other techniques implemented by other sub analyzers implemented within the gibberish analyzer 110.

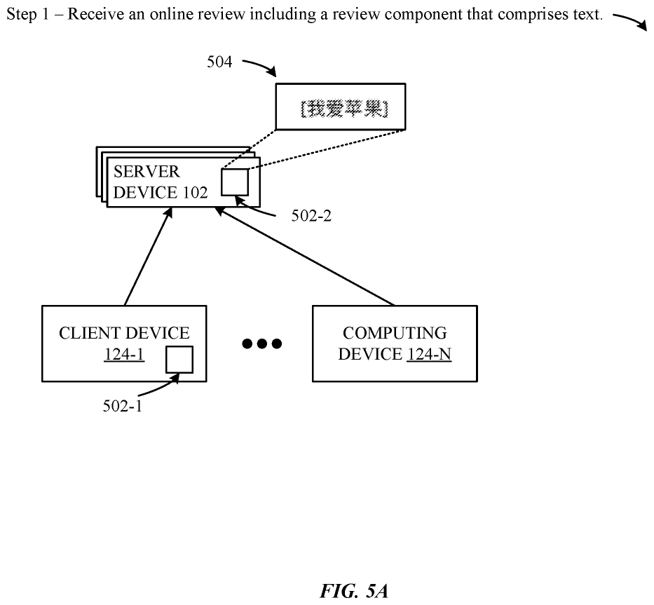

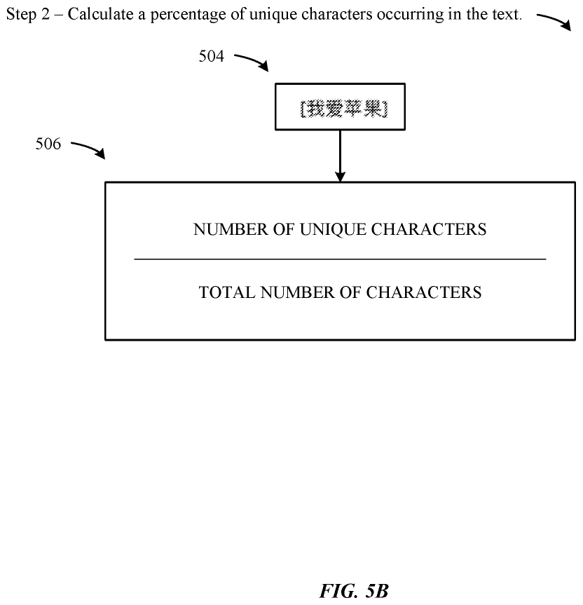

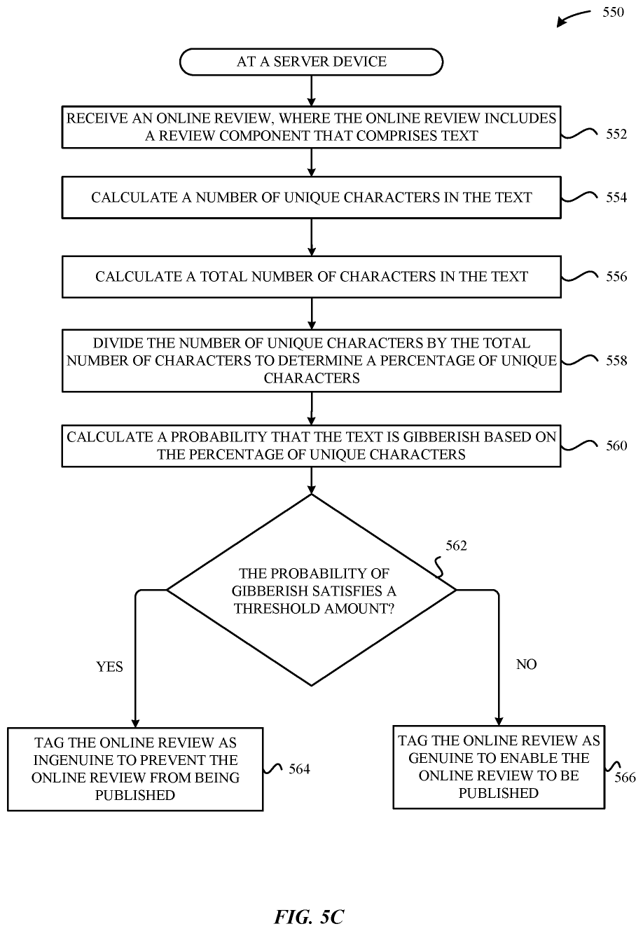

In particular, FIGS. 5A-5C illustrate conceptual and method diagrams that demonstrate the manner in which a unique character sub analyzer 112-4 (introduced in FIG. 1) can further analyze the text of a review component of an online review. The unique characters sub analyzer 112-4 can calculate a percentage of unique characters in the text of a review component. In some examples of gibberish text, a user will repeatedly input the same keys on a keyboard. This can occur when a user holds down one key in an attempt to generate longer text with minimal effort. Accordingly, the number of unique characters in the text of a review component can be used to calculate a probability of gibberish of the text.

Similar to the techniques described in FIGS. 2A-2F, 3A-3F, and 4A-4F, initially a client device 124-1 provides an online review 502-1 to the server device 102. The server device 102 receives the online review 502-1 as an online review 502-2, and the online review 502-2 includes the text 504 having the value below (5).

$$( 5 )$$

Next, as illustrated in FIG. 5B, and in response to receiving the text 504, in step 2, the unique characters sub analyzer 112-4 can calculate a percentage of unique characters occurring in the text 504. For example, the unique characters sub analyzer 112-4 can determine the number of unique characters present in text 504 (e.g., there are four unique characters) and divide that number by the total number of characters present in the text 504 (e.g., there are four total characters), which is illustrated by element 506 in FIG. 5B. Thus, in this example, the percentage of unique characters is 100%.

Accordingly, FIGS. 5A-5B illustrate an example breakdown of the manner in which the unique characters sub analyzer 112-4 can calculate the percentage of unique characters present in the text 504. In turn, the gibberish analyzer 110 can use the calculated percentage to identify an ingenuine online review, where the ingenuine online review is subsequently prevented from publishing. Additional high-level details will now be provided below in conjunction with FIG. 5C, which illustrates a method 550 that can be implemented to carry out the technique described above in conjunction with FIGS. 5A-5B. As shown in FIG. 5C, the method 550 begins at step 552, where the server device 102 receives an online review, where the online review includes a review component that includes the text 504 (e.g., as described above in conjunction with FIG. 5A).

At step 554, the server device 102 calculates a number of unique characters in the text 504 (e.g., as described above in conjunction with FIG. 5B). Next at steps 556 and 558, the server device 102 calculates a total number of characters in the text and then divides the number of unique characters by the total number of characters to determine a percentage of unique characters (e.g., as described above in conjunction with FIG. 5B). At step 560, the server device 102 calculates a probability that the text 504 is gibberish based on the percentage of unique characters. For example, if the percentage of unique characters is below a predetermined threshold, then a probability that the text 504 is gibberish may be higher.

Next, at decision block 562, the server device 102 utilizes the probability of associated with the text 504 to make a determination as to whether the online review is genuine or ingenuine. For example, if the probability of gibberish satisfies a threshold amount, at step 564, the server device 102 tags the online review 502-2 as ingenuine to prevent the online review 502-2 from being published. If the probability of gibberish does not satisfy the threshold amount, at step 566, the server device 102 tags the online review 502-2 as genuine to enable the online review 502-2 to be published.

Accordingly, FIGS. 5A-5C illustrate a manner in which the unique characters sub analyzer 112-4 implemented within the gibberish analyzer 110 of the server device 102 can use an additional technique to calculate the probability of gibberish associated with a text of a review component of an online review. The server device 102 divides a number of unique characters by a total number of characters to calculate a percentage of unique characters in the text 504. The percentage of unique characters can be used to determine a probability of gibberish of the text.

As previously described herein, the server device 102 utilizes the probability of gibberish to separate online review that are genuine from online reviews that are ingenuine and can prevent ingenuine online reviews from publishing. By using at least this fourth technique to filter ingenuine online reviews, the server device 102 enhances the overall user experience by reducing the number of ingenuine online reviews by which a prospective patron can potentially be myself. To assess the probability of gibberish, the gibberish analyzer 110 can use the technique described in FIGS. 5A-5C in isolation or in combination with other techniques implemented by other sub analyzers implemented within the gibberish analyzer 110.

In some embodiments, the techniques described in FIGS. 2A-2F, 3A-3F, 4A-4F, and 5A-5C can be used in machine learning algorithms for supervised learning. Model predictions can be used to prioritize a queue for further agent moderation and curation. Accordingly, a machine learning model can be trained on a set of techniques as described above that effectively manages a high dimensionality problem and identifies a probability of gibberish text based on sentence structure or syntax, as opposed to the meaning of a sentence.

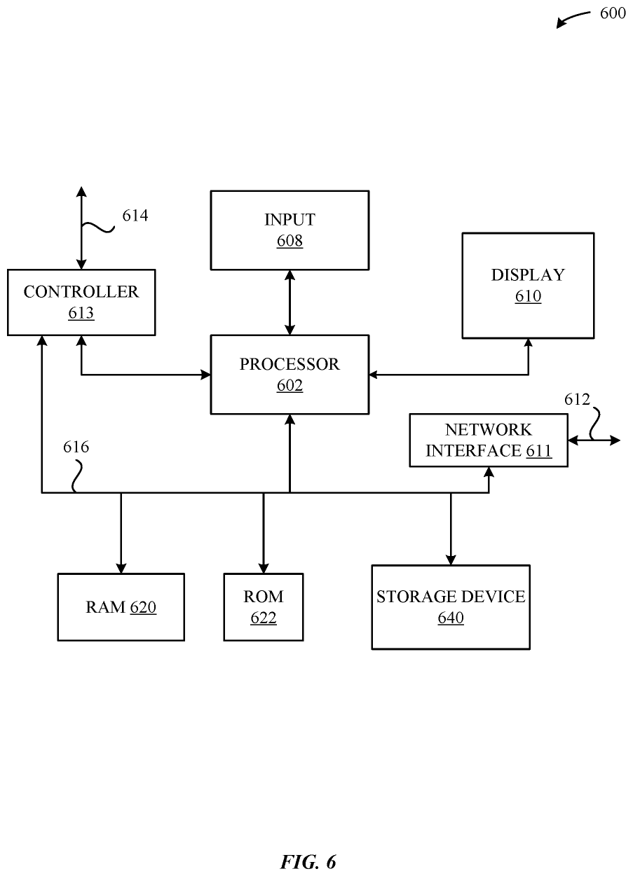

FIG. 6 illustrates a detailed view of a computing device 600 that can represent the computing devices of FIG. 1 used to implement the various techniques described herein, according to some embodiments. For example, the detailed view illustrates various components that can be included in the server device 102 or client devices 124 described in conjunction with FIG. 1. As shown in FIG. 6, the computing device 600 can include a processor 602 that represents a microprocessor or controller for controlling the overall operation of the computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, and so on. Still further, the computing device 600 can include a display 610 that can be controlled by the processor 602 (e.g., via a graphics component) to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

As noted above, the computing device 600 also includes the storage device 640, which can comprise a single disk or a collection of disks (e.g., hard drives). In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of applications executing on the computing device 600.

As described above, one aspect of the present technology is the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve the quality of online reviews. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of online review submissions, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, online reviews can be accompanied by non-personal information data or a bare minimum amount of personal information, other non-personal information available, or publicly available information.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

What is claimed is:

1. A method for identifying ingenuine online reviews, the method comprising, at a server device:
receiving an online review from a client device, wherein the online review includes a review component that comprises text;
parsing the text into two or more tokens;
assessing a probability of gibberish associated with the text, by:
assigning a part of speech to each token;
pairing consecutive tokens into speech pairings;
calculating, for each speech pairing, a conditional probability value that the speech pairing falls within a gibberish category;
aggregating the conditional probability values to calculate the probability of gibberish associated with the text; and
in response to determining that the probability of gibberish satisfies a threshold amount, tagging the online review as ingenuine to prevent the online review from being published.

2. The method of claim 1, further comprising:
receiving a second online review from a second client device, wherein the second online review includes a second review component that comprises additional text;
assessing a second probability of gibberish associated with the additional text; and
in response to determining that the second probability of gibberish is equal to or below the threshold amount, tagging the second online review as genuine to enable the second online review to be published.

3. The method of claim 1, wherein calculating, for each speech pairing, a conditional probability value that the speech pairing falls within a gibberish category, comprises:
determining a first conditional probability value from a training set of data, that for a gibberish text, the speech pairing occurs in the gibberish text;
determining a second conditional probability value from the training set of data, that for a non-gibberish text, the speech pairing occurs in the non-gibberish text;
summing the first and second conditional probability values to create a total probability of the speech pairing; and
dividing the first conditional probability value by the total probability of the speech pairing.

4. The method of claim 3, wherein the first and second conditional probability values are calculated using labeled training data.

5. The method of claim 1, wherein aggregating the conditional probability values to calculate the probability of gibberish associated with the text, comprises:
multiplying the conditional probability values to create multiplied probability values; and
dividing the multiplied probability values by a total probability, wherein the total probability represents probabilities of gibberish and non-gibberish for all speech pairings occurring in the text.

6. A method for identifying ingenuine online reviews, the method comprising, at a server device:
receiving an online review from a client device, wherein the online review includes a review component that comprises text;
separating the text into a first part that comprises letters and spaces occurring consecutively between punctuation marks within the text, and a second part that comprises letters and spaces occurring consecutively between punctuation marks within the text;
tracking a number of characters occurring within the first and second parts in a list;
identifying a largest number from the list;
calculating a probability that the text is gibberish based on the largest number; and
in response to determining that the probability satisfies a threshold amount, tagging the online review as ingenuine to prevent the online review from being published.

7. The method of claim 6, further comprising:
receiving a second online review from a second client device, wherein the second online review includes a second review component that comprises additional text;
calculating a second probability that the additional text is gibberish based on an additional largest number, wherein the additional largest number represents a largest number of characters occurring consecutively between punctuation marks within the additional text; and
in response to determining that the second probability is equal to or below the threshold amount, tagging the second online review as genuine to enable the second online review to be published.

8. The method of claim 7, wherein calculating a second probability that the additional text is gibberish based on an additional largest number, comprises:
separating the additional text into a first part of the additional text that comprises letters and spaces occurring consecutively between punctuation marks within the additional text; and a second part of the additional text that comprises letters and spaces occurring consecutively between punctuation marks within the additional text;
tracking an additional number of characters occurring within the first part of the additional text and the second part of the additional text in a second list;
identifying an additional largest number in the second list; and
calculating the second probability that the additional text is gibberish based on the additional largest number in the second list.

9. The method of claim 6, wherein tracking a number of characters occurring within the first and second parts in a list comprises:
creating a counter set to an initial value; and starting at an initial position in the text,
advancing the counter for each character that is not a punctuation mark;
recording a value of the counter in the list when a character is a punctuation mark;
resetting the counter to the initial value.

10. A method for identifying ingenuine online reviews, the method comprising, at a server device:
receiving an online review from a client device, wherein the online review includes a review component that comprises text;
for each word within the text, identifying a letter located in a predefined position of each word to produce an identified letter;
mapping individual identified letters to respective locations on a computer keyboard,
wherein the respective locations comprise one or more keys of the computer keyboard and the respective locations do not overlap;
for each of the respective locations, determining a percentage of letters located within a respective location to create an occurrence percentage;
calculating a probability that the text is gibberish based on the occurrence percentages; and
in response to determining that the probability satisfies a threshold amount, tagging the online review as ingenuine to prevent the online review from being published.

11. The method of claim 10, wherein the respective locations further comprise a first location, a second location, and a third location, and wherein mapping individual identified letters to respective locations on a computer keyboard comprises:
mapping a first identified letter to the first location, wherein the first location is a top row of keys on a QWERTY keyboard;
mapping a second identified letter to the second location, wherein the second location is a middle row of keys on the QWERTY keyboard, and wherein the third location is a bottom row of keys on the QWERTY keyboard.

12. The method of claim 11, wherein for each of the respective locations, determining a percentage of letters located within a respective location, comprises:
determining a percentage of identified letters located in the top row of keys;
determining a percentage of identified letters located in the middle row of keys; and
determining a percentage of identified letters located in the bottom row of keys.

13. The method of claim 10, wherein the text is in Chinese comprising Chinese characters, and the method further comprises:
for each Chinese character:
translating a Chinese character to a Pinyin equivalent to create a translated word;
identifying a letter located in the predefined position of the translated word.

14. The method of claim 10, wherein the text is written using letters not within a Roman alphabet, and the method further comprises:
for each word within the text:
translating the word to an equivalent word using the Roman alphabet; and
identifying a letter located in the predefined position of the equivalent word.

15. The method of claim 10, further comprising:
receiving a second online review from a second client device, wherein the second online review includes a second review component that comprises additional text;
for each word within the additional text, identifying an additional letter located in the predefined position to produce an additional identified letter;
mapping individual additional identified letters to the respective locations on the computer keyboard;
for each of the respective locations, determining an additional percentage of letters located within a respective location to create an additional occurrence percentage;
calculating an additional probability that the additional text is gibberish based on the additional occurrence percentages; and
in response to determining that the additional probability does not satisfy the threshold amount, tagging the second online review as genuine to enable the second online review to be published.

16. A method for identifying ingenuine online reviews, the method comprising, at a server device:
receiving an online review from a client device, wherein the online review includes a review component that comprises text;
calculating a percentage of unique characters occurring in the text to create the percentage of unique characters;
calculating a probability that the text is gibberish based on the percentage of unique characters; and
in response to determining that the probability satisfies a threshold amount, tagging the online review as ingenuine to prevent the online review from being published.

17. The method of claim 16, wherein calculating a probability that the text is gibberish based on the percentage of unique characters, comprises: dividing a number of unique characters present within the text by a total number of characters present within the text.

18. The method of claim 16, further comprising:
receiving a second online review from a second client device, wherein the second online review includes a second review component that comprises additional text;
calculating an additional probability that the additional text is gibberish based on a percentage of unique characters in the additional text; and
in response to determining that the additional probability is equal to or below the threshold amount, tagging the second online review as genuine to enable the second online review to be published.

19. The method of claim 16, further comprising:
for each word within the text, identifying a letter located in a predefined position to create an identified letter;
mapping individual identified letters to respective locations on a computer keyboard,
wherein the respective locations comprises one or more keys of the computer keyboard and the respective locations do not overlap; and
for each of the respective locations, determining a percentage of letters located within a respective location to create an occurrence percentage,
wherein calculating an additional probability that the text is gibberish is based on the percentage of unique characters and the occurrence percentages.

20. The method of claim 16, wherein calculating a probability that the text is gibberish based on the percentage of unique characters, comprises:
calculating a value of a largest number of words occurring between punctuation marks; and
calculating an additional probability that the text is gibberish based on the percentage of unique characters and the value of the largest number of words.
